(19) United States
(12) Patent Application Publication
(10) Pub. No.: US 2008/0109670 A1
(43) Pub. Date: May 8, 2008

(54) Power control for memories

(76) Inventors: Reino Johansson, Vaesteras (SE); Johan Ostergren, Akersberga (SE)

Correspondence Address: INFINEON TECHNOLOGIES AG;Patent Department, MUC 11.1.507, P.O. Box 221644, Munich, 80506, omitted

(21) Appl. No.: 11/593,327

(22) Filed: Nov. 6, 2006

(51) Int. Cl. G06F 1/32

(52) U.S. Cl. 713/324

(57) ABSTRACT

Apparatus comprising a memory having a plurality of memory locations to store data; a switch coupled to said memory to provide power to each memory location of said plurality of memory locations; and a controller coupled to said memory to monitor use of said plurality of memory locations, and coupled to said switch to switch it from a disabled state to an enabled state to provide power to those memory locations of said plurality of memory locations in use; and method comprising monitoring use of a plurality of memory locations in a memory to determine which memory locations are in use; and controlling a switch to turn on power to those memory locations of said plurality of memory locations in use.

### FIELD OF THE INVENTION

### Background of the Invention

Computer systems and other electronic systems generally require an increasing amount of memory. As physical dimensions of these devices grow smaller and demands on the memory grow larger, power consumption of these systems in general and the memory in particular plays an important role.

In order to reduce the power consumption, conventional systems may reduce voltage levels during low-power periods, utilize memory refresh, or use power management interfaces to turn off power to large blocks of memory.

For these and other reasons, there is a need for the invention as set forth in the following in the embodiments.

### BRIEF DESCRIPTION OF THE SEVERAL VIEWS OF THE DRAWING(S)

While the specification concludes with claims particularly pointing out and distinctly claiming as the invention, a more particular description of the invention will be rendered by reference to specific embodiments thereof, which are depicted in the appended drawings, in order to illustrate the manner in which embodiments of the invention are obtained. Understanding that these drawings depict only typical embodiments of the invention, that are not necessarily drawn to scale, and, therefore, are not to be considered limiting of its scope, embodiments will be described and explained with additional specificity and detail through use of the accompanying drawings in which:

FIG. 1 shows a functional block diagram of a portion of an apparatus in accordance with an embodiment of the invention; and

FIG. 2 shows a functional block diagram of a portion of an apparatus in accordance with another embodiment of the invention.

### DETAILED DESCRIPTION OF THE INVENTION

In the following detailed description of the embodiments, reference is made to the accompanying drawings which form a part hereof and show, by way of illustration, specific embodiments in which the invention may be practiced. In the drawings, like numerals describe substantially similar components throughout the several views. The embodiments are intended to describe aspects of the invention in sufficient detail to enable those of skill in the art to practice the invention. Other embodiments may be utilized and structural, logical or electrical changes or combinations thereof may be made without departing from the scope of the invention. Moreover, it is to be understood that the various embodiments of the invention, although different, are not necessarily mutually exclusive. For example, a particular feature, structure or characteristic described in one embodiment may be included within other embodiments. The following detailed description is, therefore, not to be taken in a limiting sense, and the scope of the invention is defined only by the appended claims, along with the full scope of equivalents to which such claims are entitled.

Reference will be made to the drawings. In order to show the structures of the embodiments most clearly, the drawings included herein are diagrammatic representations of inventive articles. Thus, actual appearance of the fabricated structures may appear different while still incorporating essential structures of embodiments. Moreover, the drawings show only the structures necessary to understand the embodiments. Additional structures known in the art have not been included to maintain clarity of the drawings.

In the following description and claims, the terms “coupled” and “connected”, along with derivatives such as “communicatively coupled” may be used. It should be understood that these terms are not intended as synonyms. Rather, in particular embodiments, “connected” and “coupled” may be used to indicate, that two or more elements are in direct physical or electrical contact with each other. However, “connected” and “coupled” may also mean that two or more elements are not in direct contact with each other, but yet still co-operate or interact with each other.

In the following description and claims, terms, such as “upper”, “lower”, “first”, “second”, etc., are used for descriptive purposes and are not to be construed as limiting. The embodiments of a device or article described herein can be manufactured, used, or shipped in a number of positions and orientations.

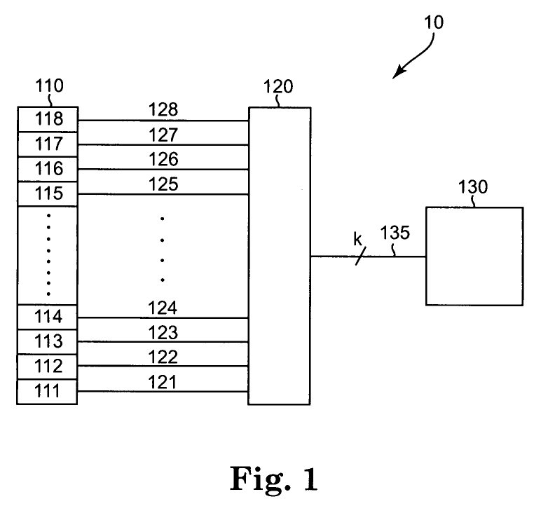

FIG. 1 shows apparatus 10 in accordance with an embodiment of the invention, that is a computer system or other electronic system. Apparatus 10 forms part of a stationary, mobile, portable or hand-held device. Apparatus 10 comprises a memory 110, the switch 120 and a controller 130. The memory 110 comprises the plurality of memory locations 111, 112, 113, 114, 115, 116, 117 and 118. The memory 110 may be implemented as an integrated circuit, for example in semiconductor technology. The memory 110 may be volatile memory. The memory 110 may be random-access memory (RAM), such as dynamic random-access memory (DRAM) or static random-access memory (SRAM). Alternatively, the memory 110 may be non-volatile memory, such as magnetic random-access memory (MRAM) or Flash memory.

The switch 120 is coupled to the memory 110 via a plurality of power lines 121, 122, 123, 124, 125, 126, 127 and 128. Each power line of the plurality of power lines 121, 122, 123, 124, 125, 126, 127 and 128 provides power to at least one memory location of the plurality of memory locations 111, 112, 113, 114, 115, 116, 117 and 118. The switch 120 may comprise a register (not shown). The register may comprise a plurality of register locations, each of which corresponding to one or more memory locations of the plurality of memory locations. The controller 130 is coupled to memory 110 and coupled to the switch 120 via a plurality of k control line 135. The controller 130 monitors use of the plurality of memory locations, and switches the switch 120 from disabled state to enabled state to provide power to those memory locations of the plurality of memory locations 111, 112, 113, 114, 115, 116, 117 and 118 in use. The controller may be implemented by instructions that are executed by a processing device, such as a processor, microprocessor or microcontroller. The controller 130 maybe implemented as an integrated circuit, or part thereof. If the controller 130 is implemented by instructions, that is software, the controller 130 may be implemented on an application level, that is an application program executed by the processor may comprise instructions implementing the controller 130. Alternatively, the controller 130 may be implemented on a system level that is a system program, for example operation system, executed by the processor. If the controller 130 is implemented by the system program, the controller 130 may be transparent on an application level, that is the controller 130 and its operation is invisible to any application program.

The memory 110 and the switch 120 may be situated on an integrated circuit. The switch 120 and the controller 130 may be situated on an integrated circuit. The memory 110, the switch 120 and the controller 130 may be situated on an integrated circuit. The integrated circuit may be a processor. The integrated circuit may be an embedded device, comprising a processor and memory.

The controller 130 controls the switch 120 using control signals on the plurality of k control lines 135, where k is an integer number. The controller 130 may multiplex the control signals on the plurality of k control lines 135. Alternatively, the controller 130 may encode the control signals on the plurality of k control lines 135, for example by using binary-coded decimals (BCD).

The control signals may identify the memory locations directly. Alternatively, the control signals may reference the memory locations relatively, that is the control signals identify the memory locations in relation to each other.

The controller 130 may control the switch 120 to turn on power to memory locations that are allocated for use, that is the switch 120 provides power to memory locations as they are reserved for use. Further, the controller 130 may be configured to control the switch 120 to turn off power to memory locations that are deallocated from use as they are freed from use. Allocation and deallocation of memory are memory management functions that support use of memory.

The controller 130 may also be configured to control the switch 120 to turn on power to a first plurality of memory locations that receive pieces of data that have been stored in a second plurality of memory locations, and to control the switch 120 to turn off power to the second plurality of memory locations after the pieces of data have been stored in the first plurality of memory locations. In addition, the controller 130 may be configured to defragment the pieces of data in the memory 110. Defragmentation is a memory management function. Defragmentation arranges pieces of data that are stored discontinuously, that is scattered, memory locations into continuous memory locations. Fragmentation of memory may be caused through repetitive allocation and deallocation of memory.

The apparatus 10 may further comprise a power supply and other elements, such as a display, keys or a keyboard, that are not shown for reasons of clarity. The power supply may comprise a mains adapter, a battery or a rechargeable battery. A feature of apparatus 10 is reduced power consumption. The reduced power consumption may result in reduced costs in terms a cheaper stationary, mobile, portable or hand-held device, reduced costs of operation or both. The reduced power consumption may reduce requirements on the power supply. The reduced power consumption may increase battery life time, reduce battery size, reduce battery weight, or a combination thereof. The reduced power consumption may also reduce heat, that is thermal budget, of the power supply, apparatus 10 or both. The reduced power consumption may also increase flexibility of the apparatus 10 with regard to a maximum amount of memory as it may become feasible to provide apparatus 10 with an increased amount of memory 110. Power consumption of the apparatus 10 only increases with regard to memory in case that additional memory is actually utilized.

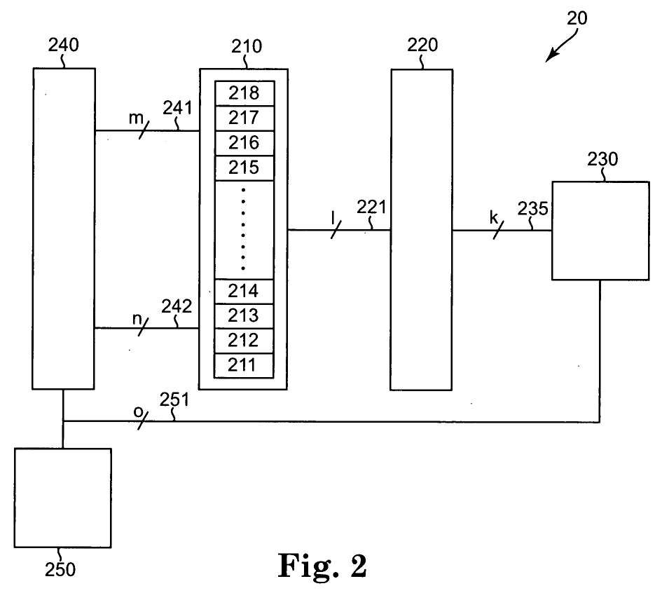

FIG. 2 shows apparatus 20 in accordance with another embodiment of the invention, that may be a computer system or other electronic system in a stationary, mobile, portable or hand-held device. Apparatus 20 may be an integrated circuit such as a central processing unit, microprocessor, microcontroller or embedded device. Apparatus 20 comprises a memory 210, a switch 220, a controller 230, a processor 240 and a register 250.

Memory 210 comprises a plurality of memory locations 211, 212, 213, 214, 215, 216, 217 and 218. Memory 210 may be volatile or non-volatile memory, that is similar to memory 110 described above with reference to FIG. 1.

The controller 230 is coupled to memory 210 to monitor which memory locations of the plurality of memory locations are in use and to provide a control output indicative of which memory locations are in use.

The switch 220 is coupled to the controller 230 via a plurality of k control lines 235, where k is an integer number, to receive the control output from the controller 230, and is coupled to the memory 210 via a plurality of l power lines 221, where l is an integer number, to couple power to selected memory locations of the plurality of memory locations 211, 212, 213, 214, 215, 216, 217 and 218, that are in use.

The processor 240 is coupled to memory 210 via a plurality of m data lines 241, where m is an integer number, and a plurality of n addressed lines 242, where n is an integer number. If the processor 240 is of a 16-bit type, m may be 16, that is the plurality of data lines 241 comprises 16 data lines, and n may be 16, that is the plurality of n address lines 242 comprises 16 address lines, providing an address space for a maximum of 216 memory locations.

The register 250 is coupled to the controller 230 and the processor 240 via a plurality of o register lines 251, where o is an integer number. The number of o register lines 251 may be less then or equal to the number of n address lines 242. The register 250 may be part of a multiple-register bank. The register 250 may be used to store an address of a particular memory location of the plurality of memory locations 211, 212, 213, 214, 215, 216, 217 and 218. Thus, the register 250 may be used as an address pointer that may be monitored by the controller 230.

The register 250 may be used as a stack pointer for a memory stack. The plurality of memory locations 211, 212, 213, 214, 215, 216, 217 and 218 is sequentially organized. The stack pointer stored in the register 250 is configured to identify a last memory location of the plurality of memory locations 211, 212, 213, 214, 215, 216, 217 and 218 along a sequence of stack memory locations that are in use.

The controller 230 is configured to monitor the stack pointer, that is register 250, and to control the switch 220 to turn on power to the stack memory locations. As the stack pointer is incremented or decremented, the controller 230 controls the switch 220 to turn on power to memory locations new to the stack memory locations, or taken from the stack memory locations, respectively.

In more detail, the processor 240 may utilize a stack, and store the corresponding stack pointer in register 250. The stack pointer identifies the last, that is top most, memory location of the stack, that is the register 250 stores a corresponding address of the last memory location. It may either be defined that the last memory location already comprises data, or that the last memory location may readily receive new data.

The processor 240 may utilize a stack in the plurality of memory locations 211, 212, 213, 214, 215, 216, 217 and 218, that is situated from memory location 215 onwards, for example. Thus, the processor 240 stores a value of an address corresponding to memory location 215 in register 250. The controller 230 monitors, via the plurality of o register lines 251, the contents of register 250, and controls the switch 220 to turn on power to memory location 215. As the processor 240 stores data on the stack and increments the stack pointer by storing a value of an address corresponding to memory location 216 in the register 250. The controller 230 monitors contents of register 250 and controls the switch 220 to turn on a power to the memory location 216 in addition to memory location 215. The processor 240 may store data in memory location 217 and store a value of an address of memory location 217 in register 250. The controller 230 monitors contents of the register 250 and controls the switch 220 to turn on power to memory location 217 in addition to memory locations 215 and 216. The processor 240 may perform a calculation, for example addition, to memory locations 217 and 216, and store a result of the calculation in memory location 216, and store the value of the address of memory location 216 in register 250, that is decrement the stack pointer. The controller 230 monitors the contents of register 250 and controls the switch to turn off power to the memory location 217, but maintain power to memory locations 216 and 215. The processor 240 may perform another calculation, for example multiplication, with memory location 216 and 215, and store a result of the other calculation in memory location 215, and store the value of the address of memory location 215 in register 250, that is decrement the stack pointer. The controller 230 monitors the contents of the register 250 and controls the switch 220 to turn off power to memory location 216, but maintain power to memory location 215.

The processor 240 may utilize a plurality of stack pointers for a particular stack. The controller 230 may then monitor the plurality of stack pointers and control the switch 220 to turn on power to stack memory locations up to the top most memory location of the stack.

The processor 240 may utilize a plurality of stacks, each of which comprising one or more stack pointers. The stack pointers may be stored in parts of the multiple-register bank.

The memory 210 may be on-chip cache memory or multiple-register bank.

Although specific embodiments have been illustrated and described herein, it will be appreciated by those of ordinary skill in the art, that any arrangement which is calculated to achieve the same purpose may be substituted for the specific embodiments shown. It is to be understood, that the above description is intended to be illustrative and not restrictive. This application is intended to cover any adaptations or variations of the invention. Combinations of the above embodiments and many other embodiments will be apparent to those of skill in the art upon reading and understanding the above description. The scope of the invention includes any other embodiments and applications in which the above structures and methods may be used. The scope of the invention should, therefore, be determined with reference to the appended claims along with the full scope of equivalents to which such claims are entitled.

It is emphasized that the Abstract is provided to comply with 37 C.F.R. section 1.72(b) requiring an abstract that will allow the reader to quickly ascertain the nature and gist of the technical disclosure. It is submitted with the understanding, that it will not be used to interpret or limit the scope or meaning of the claims.

What is claimed is:

1. An apparatus, comprising:
a memory comprising a plurality of memory locations;
a switch coupled to said memory to provide power to each of said plurality of memory locations; and
a controller coupled to said memory to monitor use of said plurality of memory locations, and coupled to said switch to switch it from a disabled state to an enabled state to provide power to memory locations of said plurality of memory locations in use.

2. The apparatus of claim 1, wherein:
said switch comprises a register.

3. The apparatus of claim 2, wherein:
said register has register locations, each of which corresponds to one or more of said plurality of memory locations.

4. The apparatus of claim 1, wherein:
said controller is implemented by instructions executed by a processor.

5. The apparatus of claim 4, wherein:
said controller is supported by a circuit.

6. The apparatus of claim 4, wherein:
said controller is implemented as circuitry.

7. The apparatus of claim 1, wherein:
said controller is implemented on an application level.

8. The apparatus of claim 1, wherein:
said controller is implemented on a system level.

9. The apparatus of claim 8, wherein:
said controller is transparent to an application level.

10. The apparatus of claim 1, wherein:
said memory and said switch are disposed on an integrated circuit.

11. The apparatus of claim 1, wherein:
said switch and said controller are disposed on an integrated circuit.

12. The apparatus of claim 1, wherein:
said memory, said switch and said controller are disposed on an integrated circuit.

13. The apparatus of claim 12, wherein:
the integrated circuit is an embedded device.

14. The apparatus of claim 12, wherein:
the integrated circuit is a processor.

15. The apparatus of claim 1, wherein:
said controller controls said switch using multiplexed control signals.

16. The apparatus of claim 15, wherein:
said control signals are encoded.

17. The apparatus of claim 1, wherein:
said controller is configured to control said switch to turn on power to memory locations that are allocated for use.

18. The apparatus of claim 17, wherein:
said controller is configured to control said switch to turn off power to memory locations that are deallocated from use.

19. The apparatus of claim 1, wherein:
said controller is configured to control said switch to turn on power to first memory locations that receive first pieces of data; and
said controller is configured to control said switch to turn off power to second memory locations that stored said first pieces of data.

20. The apparatus of claim 19, wherein:
said controller is configured to defragment said pieces of data in said memory.

21. The apparatus of claim 1, wherein:
said plurality of memory locations are sequentially organized;
a stack pointer is configured to identify a last memory location of said plurality of memory locations along a sequence of stack memory locations that are in use; and
said controller is configured to monitor said stack pointer and to control said switch to turn on power to said stack memory locations.

22. An apparatus, comprising:
a memory array having a plurality of memory locations;
a controller coupled to said memory array to monitor which memory locations of said plurality of memory locations are in use and provide a control output indicative of which memory locations are in use; and
a switch coupled to receive said control output from the controller and responsive thereto to couple power to selected memory locations which are in use.

23. A method, comprising:
monitoring use of a plurality of memory locations in a memory to determine which memory locations are in use; and
controlling a switch to turn on power to those memory locations of said plurality of memory locations in use.

24. A method, comprising:
monitoring a plurality of memory locations in a memory to determine whether selected memory locations of said a plurality of memory locations are in use and providing a control output indicative of which memory locations are in use; and
providing power to selected ones of said plurality of memory locations, at least partially in response to said control output.
